(19) United States
(12) Patent Application Publication
(10) Pub. No.: US 2025/0038436 A1
(43) Pub. Date: Jan. 30, 2025

(54) SLIDE-FIT ELECTRICAL CONTACT TERMINATION FOR MATING SOLID ROUND CONTACTS IN PCBS OR CYLINDRICAL SOCKETS

(71) Applicants: Gaby Cristian MINDRECI, Pibrac (FR); MINDREACH I2I, SL, Andorra La Vella (AD)

(72) Inventors: Gaby Cristian MINDRECI, Pibrac (FR); Eduard POPSOR, Maple (CA)

(73) Assignees: Gaby Cristian MINDRECI, Pibrac (FR); MINDREACH I2I, SL, Andorra La Vella (AD)

(21) Appl. No.: 18/714,596

(22) PCT Filed: Nov. 30, 2022
(86) PCT No.: PCT/IB2022/061561

§ 371 Date: May 30, 2024

Related U.S. Application Data
(60) Provisional application No. 63/284,600, filed on Nov. 30, 2021.

(51) Int. Cl. H01R 12/58; H01R 12/70; H01R 12/72

(52) U.S. Cl. CPC H01R 12/58; H01R 12/7058; H01R 12/724

(57) ABSTRACT

This invention describes an improved contact termination interface assembly between pins or male contacts and via holes in PCBs or backplanes or simple sockets or female contacts. This invention permits to achieve reliable electromechanical connection between a connector directly with a PCB thereby eliminating the need for a second mating connector to be installed on the PCB. This invention offers an alternative to mounting connectors to PCBs other than through-hole solder or press-fit technology. This invention allows a unibody connector to connect a daughter board directly to a mother board either in parallel or right-angle orientation. One embodiment of this invention allows for a connector to achieve multiple blind-mating cycles with a backplane using a self-guiding, self-retractive, contact protection face, which applies pressure on all contacts once inserted into the backplane to achieve reliable electromechanical connection. Other embodiments of this invention permit male contacts to mate directly with metallized via holes, tube sockets or female contacts without any additional retention or pressure elements required to create the electromechanical connection. Other embodiments allow to reach a fully mated condition between the mating counterparts with zero insertion force because the offsetting pressure between the contacts is applied after the mating of the counterparts.

### FIELD OF THE INVENTION

The present invention relates to electrical and electronic connectors whose contact terminations are usually connected to printed circuit boards (hereinafter also referred to as PCBs), daughter cards or backplanes by through-hole soldering process or by in-hole press-fit technology. This invention embodies a configuration of offsetting elements which achieve excellent electromechanical interface in a manner which eliminates the need to solder contacts to PCBs and eliminates the need to employ cross-sectional interference contact geometry, also known as press-fit. This offsetting configuration of contact interface is equally viable for mating a pin or male contact into a socket or female contact that is a simple tube.

### BACKGROUND OF THE INVENTION

The myriads of electrical and electronic connector types developed by multiple manufacturers for electrical and electronic applications in all industries, employ typically three basic configurations: cable to cable connectors, cable to board connectors, or board to board connectors. In some cases, connectors must feed through enclosure walls, but the three basic configurations remain the same, only some panel mounting provisions are added to the connector bodies to permit feeding the circuit inside or outside enclosure walls. In some cases, connectors are designed to mate to busbars but the method of connection at the electrical interface is achieved either by soldering or by in-hole press-fit technology.

There is a current need in the art, to develop an alternative configuration of connecting terminations of connectors' contacts to metallized via holes in PCBs, which are currently achieved either by through-hole soldering or in-hole press-fit technology.

For example, through-hole soldering is a well-known process by which components are mounted to a PCB using physical leads. These leads are inserted through the metallized holes into the PCB. The leads are then soldered from the opposite side of the board to keep the component in place and achieve the electrical connection. Through-hole soldering requires detailed inspection for quality conformance, and it is a costly process therefore in many applications it is preferred to employ solderless interface technologies.

On the other hand, in-hole press-fit technology constitutes relevant related art. In-hole press-fit technology is a method of achieving electromechanical contact by dimensional interference in the same cross-section. In-hole press-fit technology is achieved by three distinct interface systems:

The first interface system is rigid press-fit, which is a destructive press-fit interface system where a contact termination with a square profile is forced into a round PCB via hole. The sharp square corners exceed the inside diameter of the hole and as the contact is pressed into the hole, the edges cut into the plated through barrel and damage the plating and the conductive cylinder wall. Due to the destructive nature of the assembly, this type of assembly is not accepted in environments where vibrations and shock are present or where the connection must be repeated or cycled more than one time.

The second interface system is hard compliant press-fit which is also a destructive interference interface system, generally employed on terminations of contacts achieved by stamping process. A shape with a profile like an “eye of the needle” is stamped-out at the termination end of the contact and after the stamping is completed, the contact termination end is plated, generally with lead-free tin or other finishes. In this case however, the edges of the stamping remain sharp due to the square angles of the cut. When the contact termination is pressed into the via hole, the eye of the needle feature permits the contact to comply or collapse when forced into the hole, but the sharp edges still cut and destroy the plating finish found on the inner walls of the via hole. A distinct disadvantage of hard compliant press-fit geometry is that the conductor's cross-sectional area is reduced in the active zone of interference thereby decreasing the current carrying capacity of the conductor in that zone.

The third interface system is low force compliant press-fit, a less destructive press-fit interface system, which is also based on interference force between the outside diameter of the contact termination and the inside diameter of the via hole in the PCB. A contact termination with low force compliant press-fit geometry is usually achieved by machining round bars (eliminating the sharp edges) and carving out either a full slot longitudinally resembling an eye of the needle or by carving out a “U”-shaped channel longitudinally, with a depth that goes past the center point of the cross-section of the contact in such way as to offer a method for the contact termination circumference to collapse (or comply) when pressed into the via hole. This type of interference fit requires reasonably high forces to press the contact terminations into the via holes even though the moniker “Low force compliant press-fit” suggests that the insertion force is low but the designation of “low” is in comparison to the forces of insertion required by rigid press-fit and hard compliant press-fit technologies. The justification that the insertion force of a “low force compliant press-fit”-designated interface system is yet elevated, is shown through evidence resulted from inspections carried out by cross-sectioning PCBs after the contacts were inserted showing clearly stress indicators into the walls of the PCB material in form of random micro-cracks displaced around the via hole barrel and visible deformation of the metallized via walls and in some cases delamination of the metallic ring at the top of the barrel after extraction. In every case, the plating finish on the inner wall of the via hole suffers abrasion due to the friction between the surfaces during the insertion cycle. This type of low-force compliant termination is sometimes rated as a repeatable connection up to three cycles as it is characterized by an intrinsic elastic property of the base material such as a phosphorous bronze alloy. Low-force compliant press-fit terminations can be equally achieved through the stamped and formed process by forming the contact termination with a profile in the shape of the letter “C” which subsequently is forced to collapse as it is pressed into the via hole. This process is however limited to contact terminations of larger diameters, generally used in power applications rather than tiny diameters used for signal transmission. A distinct disadvantage of low-force compliant press-fit geometry is that the conductor's cross-sectional area is reduced in the active zone of interference thereby decreasing the current carrying capacity of the conductor in that zone.

### SUMMARY OF THE INVENTION

This invention describes a novel system to achieve excellent electromechanical connection or interface between a solid contact termination or pin contacts with a round cross-section and a via hole in a PCB or a drilled hole into a bus bar or a cylindrical socket/female contact in the shape of a straight tube. Furthermore, given the specific functional characteristic of the design, this interface system can be employed as a repeatable, direct mating system between a connector and a PCB thereby eliminating the need to transition between permanent connection to repeatable connection generally achieved by employing electrical connectors as known generically.

To exemplify these points, let's consider the need to connect a daughter card to a mother board at right angles, the traditional configuration is to mount a male or plug connector with 90° bent contact terminations to the daughter card and to mount a female or socket connector with straight contact terminations to the mother board. The mounting of the contact terminations can be achieved either by through-hole solder or by through-hole press-fit as described in the prior section in points 1, 2 and 3. Once the two mating connectors are mounted on the respective boards, the two assemblies can be connected by plugging the respective connectors into each other thereby achieving the electrical connection between the daughter card and the mother board. The purpose of the connector is to allow the connection between the daughter card and the mother board to be made and broken from few times to several hundreds of times depending on the design features found at the mating interface between the two connectors.

The present invention eliminates the need to employ two separable connectors which can be substituted by one single-body connector which employs the Slide-Fit Electrical Contact Termination (hereinafter referred to as S-FECT) feature that allows the connector to mate directly and securely with both the daughter card and with the mother board. On the 90° termination side, the connector would be attached permanently to the daughter card employing a permanent, fixed, or secured embodiment of the S-FECT interface system, and on the straight side, the connector will employ a blind-mating or self-guiding feature designed to align the mating face directly with the hole pattern on the mother board and to permit the guiding of the contacts into their corresponding via holes. Once the contacts are partly inserted into their corresponding via holes, a protective offsetting faceplate with an identical pattern to the footprint on the mother board, will be forced by a complementary group of internally offset guide pins, in such way as to tension the electrical contacts into their respective via holes while the connector body is maintained in the same position of reference with respect to both the daughter card and the mother board. The only element which shifts is thereby the protective offsetting faceplate which is designed to slide inwards toward the connector body to permit the contacts (or pins) to protrude outwardly into the via holes on the mother board once the connector is guided correctly into its desired position and once the contacts are partially inserted, the faceplate is forced to offset at right angle to the longitudinal axis of contacts in order to achieve the slide-fit interface.

In addition, the permanent, fixed, or secured embodiment of the S-FECT interface system can be applied to any connector's termination as the primary method to achieve repeatable or permanent electromechanical connection between the connector's contact terminations and printed circuit boards or bus bars when the connectors' contact terminations are displaced at straight or right-angle configurations.

Finally, the S-FECT interface system can equally be employed at the interface between two separable connectors since the active action of the electrical connection is executed by the male contact or pin, therefore the receptacle part also known as socket or female side only needs to feature a simple tube cavity without any features designed to create electrical contact at the interface.

In summary, the Slide-Fit Electrical Contact Termination Technology is an electromechanical interface technology based on a mechanical offset applied on the male contact resulting in a reliable interface between the male contact or pin and its mating socket, female contact or metalized through hole in a PCB. The offsetting system can be classified in three distinct embodiments: The first embodiment is a pre-insertion offset where the male contact is pre-formed with an offset applied in the zone of interface with its mating counterpart. The second embodiment is a post-insertion offset where a sliding element applies pressure perpendicularly to the axis of the male contact during the mating process starting soon after the contact is penetrating its mating counterpart and ending when the fully mated condition is achieved. The third embodiment is a post-insertion offset where a sliding element applies pressure perpendicularly to the axis of the male contact after the contact has reached its fully mated condition thereby achieving a condition known as zero insertion force between the mating counterparts.

### BRIEF DESCRIPTION OF THE DRAWINGS

The accompanying drawings are not intended to be drawn to scale. In the drawings:

FIG. 1A corresponds to a perspective view of the first embodiment of the present invention, wherein the S-FECT Technology is applied in an assembly of a generic D-subminiature connector and a PCB, shown in final installed state.

FIG. 1B corresponds to a detailed top view of the first embodiment of the present invention, showing the position of the cross-section B-B utilized in FIGS. 1C and 1D.

FIG. 1C corresponds to a cross-sectional view in lines B-B of FIG. 1B, shown in a pre-installation position with respect to the PCB below.

FIG. 1D corresponds to a cross-sectional view in lines B-B of FIG. 1B, shown in mounted position into the PCB. As no interference is present between the outside diameters of the contacts and the inside diameters of the holes into the PCB, the mounting of the connector into the PCB is realized effortlessly without any pressing tools simply by aligning the contacts with the footprint in the PCB.

FIG. 1E corresponds to a detailed top view of the first embodiment of the present invention, in a pre-mounting stage of assembly with the positioning of the cross-section in line D-D.

FIG. 1F corresponds to a cross-sectional view in lines D-D of FIG. 1E, shown in a pre-mounted position with the offsetting piece prior to being positioned.

FIG. 1G corresponds to a cross-sectional view in lines D-D of FIG. 1E, shown in a pre-mounted position with the offsetting piece in place.

FIG. 1H corresponds to a detailed top view of the first embodiment of the present invention, in a securing stage of assembly with a mounting screw placed in position prior to installation and an indication of the positioning of the cross-section in plane C-C.

FIG. 1I shows the cross-sectional view in line C-C of FIG. 1H.

FIG. 1J corresponds to a detailed top view of the first embodiment of the present invention, in a secured stage of assembly with a mounting screw showed fully installed and an indication of the positioning of the cross-section in plane C-C.

FIG. 1K corresponds to a cross-sectional view in lines C-C of FIG. 1J, showing the mounting screw fully installed in a final position.

FIG. 1L corresponds to a detailed top view of the first embodiment of the present invention, in fully installed configuration indicating the position of the cross-section in lines B-B

FIG. 1M corresponds to a cross-sectional view in lines B-B of FIG. 1L, shown in a final installed position with the contacts tensioned in slide-fit mode achieving a good electrical interface with the holes in the PCB.

FIG. 1N corresponds to the cross-sectional view of FIG. IM, detailing the areas where the electrical contact is achieved between the plated through holes in the PCB and the contact terminations.

FIG. 2A corresponds to an exploded view of the second embodiment of the present invention, wherein the S-FECT Technology is applied in a single-piece daughter-card to backplane rectangular connector.

FIGS. 2B and 2C show perspective views of the second embodiment of the present invention of FIG. 2A, prior to being installed.

FIG. 2D corresponds to a partial cross-sectional view of the second embodiment of the present invention of FIG. 2A, shown in a pre-installed position.

FIG. 2E corresponds to a detailed side view of FIG. 2D.

FIG. 2F corresponds to a partial cross-sectional view of the second embodiment of the present invention of FIG. 2A, shown in an installed position.

FIG. 2G corresponds to a detailed side view of FIG. 2F.

FIG. 2H corresponds to a detailed front view of the second embodiment of the present invention of FIG. 2A.

FIG. 2I corresponds to a cross-sectional view in lines A-A of FIG. 2H, shown in a pre-placed position, shown in an initial installation position.

FIG. 2J corresponds to a cross-sectional view in lines A-A of FIG. 2H, shown in a pre-placed position, shown in an intermediate installation position.

FIG. 2K corresponds to a cross-sectional view in lines A-A of FIG. 2H, shown in a placed position, shown in a final installation position.

FIG. 2L corresponds to a cross-sectional top view of the single-piece connector completely installed and locked onto daughterboard PCB completely blind-mated with the backplane PCB.

FIG. 2M corresponds to a cross-sectional side view in lines D-D of FIG. 2L.

FIG. 2N corresponds to a detailed top view of FIG. 2L.

FIG. 2O corresponds to a detailed side view of FIG. 2M.

FIG. 2P corresponds to a side view of the second embodiment of the present invention, with the protective cover in extended position.

FIG. 2Q corresponds to a cross-sectional top view in lines B-B of FIG. 2P.

FIG. 2R corresponds to a side view of the second embodiment of the present invention, with the protective cover in retracted position.

FIG. 2S corresponds to a cross-sectional top view in lines B-B of FIG. 2R.

FIG. 3A corresponds to a cross-sectional view of the third embodiment of the present invention, shown in an initial installation position.

FIG. 3B corresponds to a cross-sectional view of the third embodiment of the present invention of FIG. 3A, shown in an intermediate installation position.

FIG. 3C corresponds to a cross-sectional view of the third embodiment of the present invention of FIG. 3A, shown in a final installation position.

FIG. 3D corresponds to a detailed side view of FIG. 3C.

FIGS. 4A and 4B present an alternative embodiment of the S-FECT Technology featuring a pre-insertion offset pre-formed on the male contact.

FIGS. 5A and 5B present another embodiment of the S-FECT Technology with a different version of pre-insertion offset pre-formed on the male contact.

FIGS. 6A to 6E present another embodiment of the S-FECT Technology showing in cross-sectional view how S-FECT interface is made automatically between a male and female connector during the coupling action of the two.

### DETAILED DESCRIPTION OF THE INVENTION

The Slide-Fit Electrical Contact Termination or S-FECT is an interface system designed to achieve excellent electromechanical contact between pins or male contacts directly with metallized via holes in PCBs or with plain sockets which do not require any type of retention system in the barrel. Within the scope of this invention, it should be noted that the S-FECT Technology can be applied to a multitude of connector types such as rectangular connectors, circular connectors, modular connectors, irregular shaped connectors, at the interface between the contact terminations for both 90° and straight termination orientations and the PCBs or bus bars or a combination thereof according to any application requirements. S-FECT Technology can equally be applied at the interface between two mating connectors where the active engagement is achieved by the male contact or pin, thereby allowing the female contact or socket to be a simple tube or barrel which, for increased reliability, can feature a solid, uninterrupted ring at the point of entry, also known as a closed entry socket. In the following paragraphs, the present invention of the S-FECT Technology will be described with six representative embodiments of the Slide-Fit Electrical Contact Termination interface system, but the application of this technology is not limited to these six embodiments understanding that it is difficult to capture all possible connector shapes and contact housing configurations.

In addition, it is important to mention that a fundamental component for the effectivity of S-FECT Technology is the alloy types selected for the manufacturing of the male contacts or pins which comprise the active feature for making and maintaining electrical contact. The alloys required for the manufacturing of these contacts shall possess adequate modulus of elasticity, and the elastic property of the base material shall be sustained throughout the operating temperature range of the connector with an adequate margin of derating. Some example of copper alloys with adequate elastic properties are beryllium copper alloys and some phosphorus bronze alloys. This outline of copper alloys type is non-exhaustive, the scope of this document is to underline that the technology is dependent on the contact performance throughout the elastic deformation range of the material as a function of the contact's diameter, protrusion length, operating temperature range, storage temperature range, and processing or manufacturing temperature range, with a reasonable margin of safety designed accordingly for each application to ensure an adequate safety gap to the material's limit into plastic deformation.

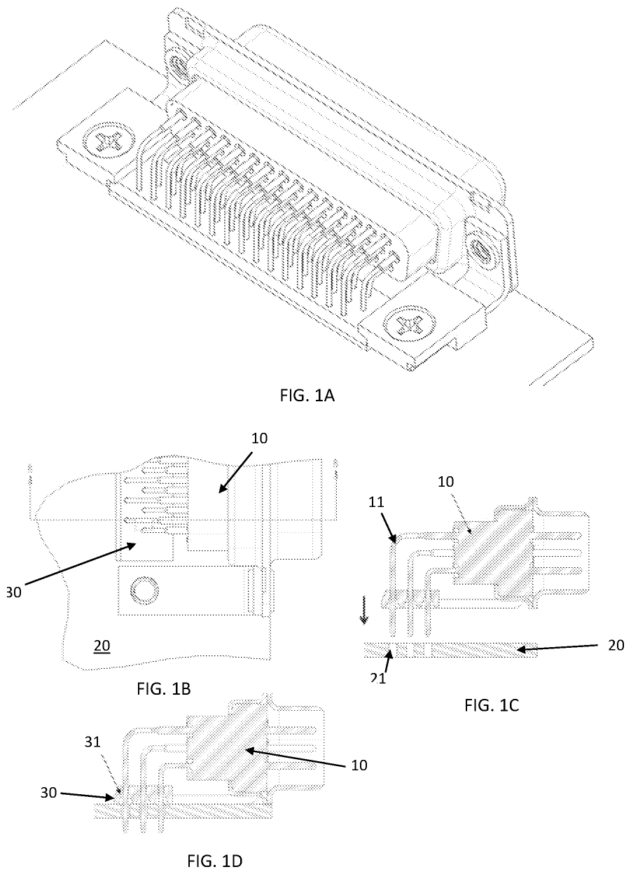

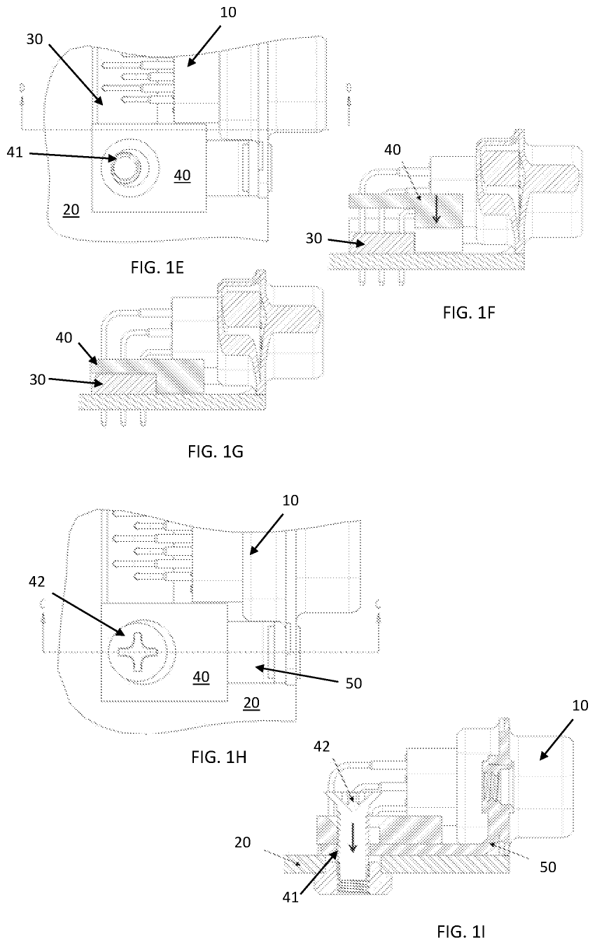

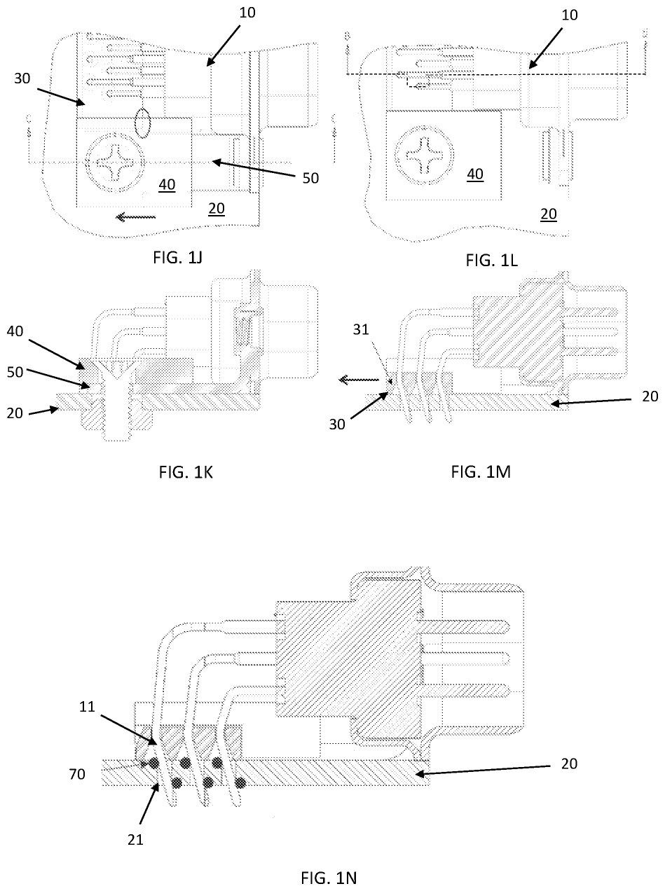

The first embodiment of the S-FECT Technology depicts a generic Subminiature-D connector (10) with 90° bent contact terminations as shown in final assembled state onto a PCB in FIGS. 1A, 1J to 1N, achieving a permanent electromechanical connection. The assembly process of the first embodiment initiates in FIGS. 1B to 1D, where it is shown how the generic D-subminiature connector (10) having a plurality of contact terminations (11) are placed into a corresponding footprint (21) on a PCB (20), up to the point when the connector (10) fully rests onto the PCB (20), and an alignment bar (30) is positioned flat on top of the PCB (20). Such alignment bar (30) features a corresponding plurality of chamfered holes (31) configurated and designed specifically to permit a spacing which allows the contact terminations (11) to deform within their elastic limit without creating shear. Preferably, the contact terminations (11) are solid pin contacts or terminations with a round cross-section, and the footprint (21) is a plurality of plated or metalized through hole in the PCB or any other cylindrical socket/female contact.

As the assembling process continues, the next stage is depicted in FIGS. 1E to 1G, where a slide-fit offsetting action element (40) is mounted in offset position over a mounting hole (41) and in direct contact with the alignment bar (30). It should be noted that only one side of the offsetting system is shown. Then, FIGS. 1H and 1I shown in cross-section C-C how a mounting mechanism (42), preferably a mounting screw or similar, retains the connector (10) in its intended position on the PCB (20) through the mounting bracket (50) which is secured to the body of the connector (10).

To conclude the installation of the assembly and activate the effects of the S-FECT Technology of the present invention, FIGS. 1J to 1M show the final mounted assembly. Particularly, FIG. 1M shows that when the mounting mechanism (42) is fastened into the 30 mounting hole (41), the mounting mechanism interacts with the slide-fit offsetting action element (40) by displacing it laterally. Then, the slide-fit offsetting action element (40) subsequently forces the alignment bar (30) to slide into the final position, forcing the contact terminations (11) to jam into the PCB (20) via holes, while the elastic deformation on the contact terminations (11) is permitted to occur in the chamfered holes (31) within the alignment bar (30). Finally, FIG. 1N highlights areas of permanent electrical contact (70) between the contact terminations (11) and the metallized via hole in the PCB (20). Note the ratio between the PCB footprint (21) via hole inner diameter and the contact terminations (11) outside diameter to emphasize the Slide-Fit action of the assembly in this embodiment of the invention.

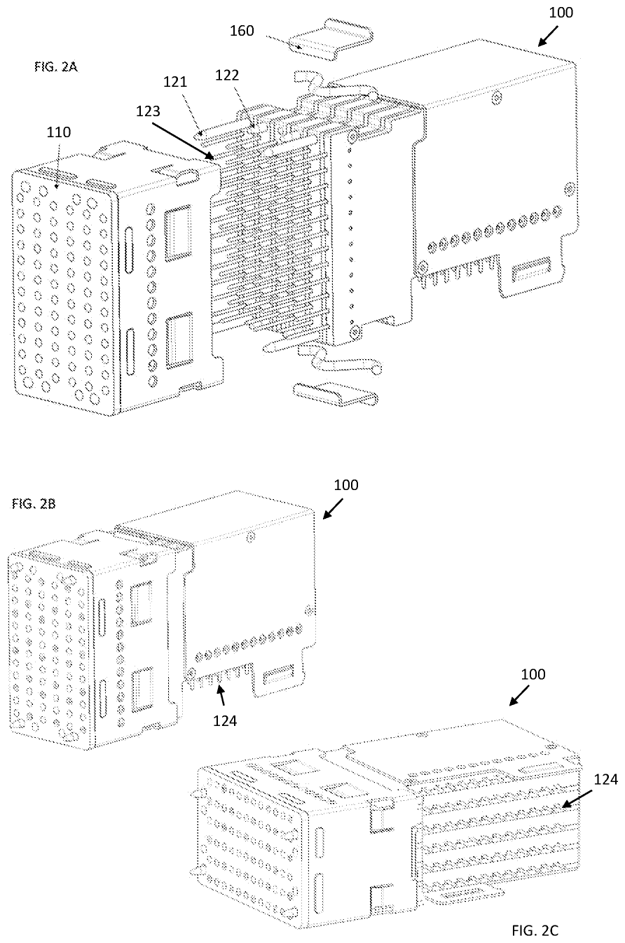

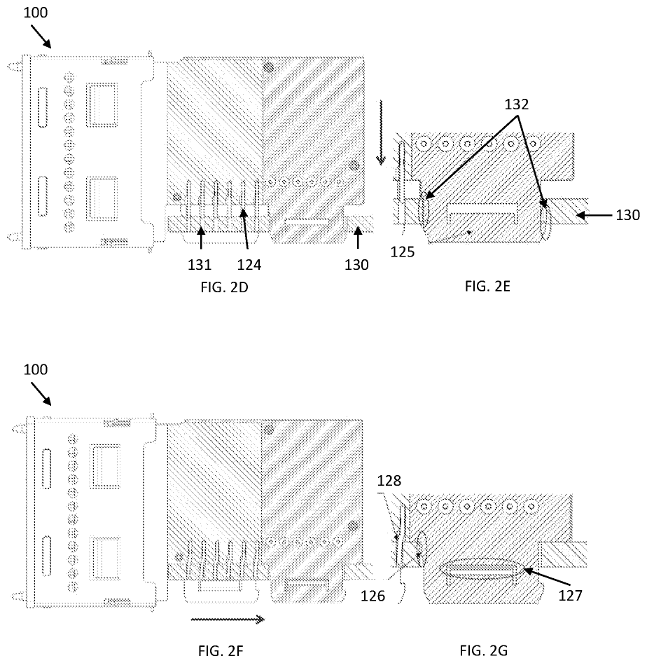

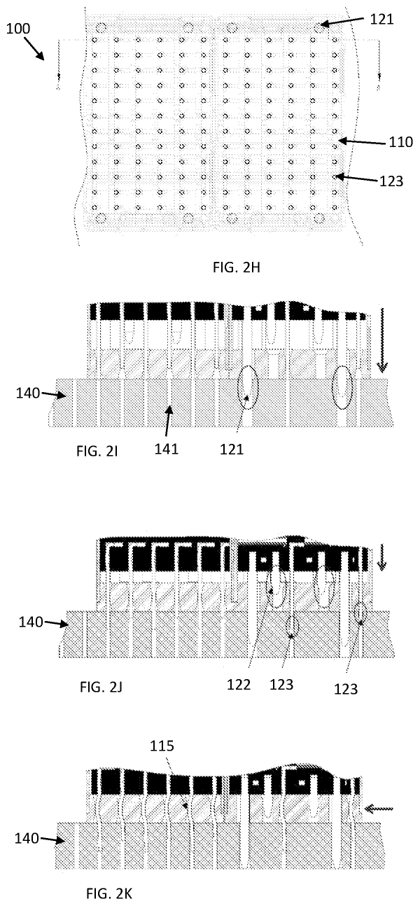

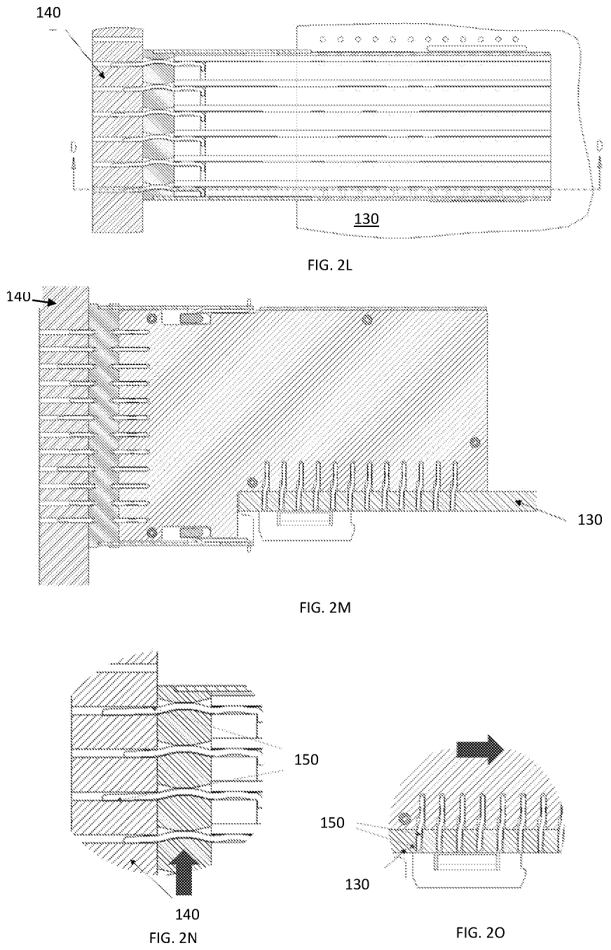

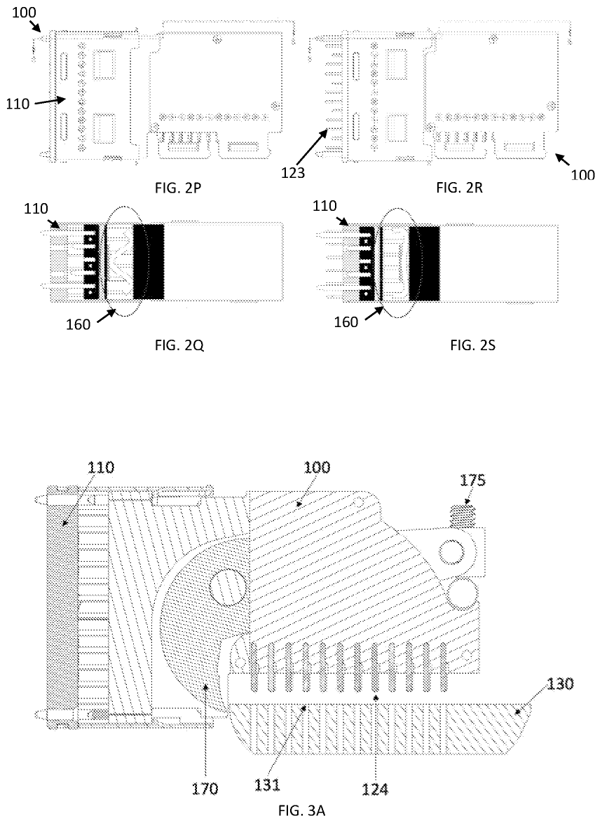

FIGS. 2A to 2C show the second embodiment of the S-FECT Technology, wherein a rectangular single-piece connector (100) is featuring the Slide-Fit Electrical Contact Termination Technology on both sides of the connector at right angle orientation to each other. In a preferred embodiment, the single-piece connector (100) mates directly with a backplane PCB (not shown) in its front, and mates directly with a daughterboard PCB (not shown) in its bottom. A sliding, locking and auto-retracting protective cover (110) is designed to permit a plurality of connector guide pins (121) to precisely align the connector (100) with a footprint on a backplane PCB (not shown) and to permit a plurality of sliding and locking offsetting guide pins (122) to achieve the electrical connection between a plurality of pin contacts (123) directly with a corresponding plurality of metalized via holes into the backplane PCB. In addition, the single-piece connector (100) includes a self-retractive action mechanism (160), in this embodiment shown in the shape of the letter “W”, which is the feature that permits the protective cover (110) to auto-retract when the single-piece connector (100) is unplugged from the backplane to protect the pin contacts (123). Referring to FIGS. 2B and 2C, the rectangular single-piece connector (100) also achieves the electrical connection between a plurality of pin contacts (124) directly with a corresponding plurality of metalized via holes into the daughterboard PCB.

FIGS. 2D and 2E show the single-piece connector (100) before being installed onto a PCB (130). preferably a daughter card PCB (indicated direction downwardly by an arrow) the pin contacts (124) are precisely aligned with the footprint (131) on the PCB (130) by a locking mechanism, in this embodiment being a guiding lock tab (125) with zones of assembly alignment (132). As the installation process continues, the single-piece connector (100) is placed onto the PCB (130) as depicted in FIGS. 2F and 2G, where a slide-fit offsetting action element (126) is configured into the design of the guiding lock tab (125), (indicated direction laterally by an arrow). When the single-piece connector (100) is fully inserted into the PCB (130). the pin contacts (124) are fully locked into the via holes achieving effective electrical connection, and at the same time, the guiding lock tab (125) locks automatically in place via a lock lid (127) to retain the single-piece connector (100) securely to the PCB (130). Accordingly,

this installation process completely separates the mechanical function from the electrical function of the device. The pin contacts (124) are attached to a support element that is provided with a corresponding plurality of cavities (128) aside each pin contact (124), such as to permit elastic deformation for the pin contact termination over the length of each cavity and not suffer shearing. As mentioned before, the Slide-Fit Electrical Contact Termination Technology as illustrated in this exemplary embodiment should not be limited to this specific configuration as it is applicable to any connector termination encountering via holes in PCBs.

Once the installation of the single-piece connector (100) on the daughter card is completed, the card is ready to be coupled via the single-piece connector (100) directly with the backplane. When cards are plugged into backplanes the connection is made in blind-mating action which means the connector must have means to guide itself precisely over the footprint found on the backplane prior the commencement of mating between the contacts and the metallized via holes in the backplane.

Referring now to FIGS. 2H to 2K, the single-piece connector (100) guides itself positioning the sliding protective cover precisely over a footprint (141) on a backplane PCB (140) with the help of the connector guide pins (121). As can be noted in FIG. 2I, the pin contacts (123) start protruding into the backplane via holes as the connector is being pushed forward (indicated direction forwardly by an arrow), and the protective cover (110) slides towards the body of the single-piece connector (100) allowing the pin contacts (123) to protrude 20) into the backplane via holes. FIG. 2J shows the protective cover (110) retracted to the point just before the slide-fit action is about to commence with the help of the short offsetting guide pins (122). In FIG. 2K, as the single-piece connector (100) is pushed fully against the backplane (140), the offsetting guide pins (122) force the protective cover (110) to slide to the left (indicated direction laterally by an arrow), thereby creating adequate electrical contact 25 between the pin contacts (123) and the via holes into the backplane PCB (140). The elastic tensioning in each pin contacts (123) is achieved by a slide-fit offsetting action element (115) into the cavities of the sliding protective cover (110), wherein the slide-fit offsetting action element laterally slide with respect to the rest of the cover. The slide-fit offsetting action element (115) is designed to allow the pin contacts (123) to undergo elastic deformation and 30 not to experience shearing. As mentioned before, the Slide-Fit Electrical Contact Termination Technology as illustrated in this exemplary embodiment should not be limited to this specific configuration as it is applicable to any connector termination being blind mated with a PCB, backplane or with another connector.

In FIGS. 2L and 2M we can see the single-piece connector (100) completely installed and locked onto PCB (130) and completely blind-mated with the backplane (140), in both front and bottom applying the slide-fit terminations fully engaged electrically to the via holes. FIGS. 2N and 2O, areas of electrical contact (150) are achieved by the slide-fit technology between the pin contacts (123, 124) and the PCBs (130, 140). The arrows show the direction of movement of the sliding elements which force the pin contacts (123, 124) in final position thereby achieving the desired electromechanical interference with the metallized via holes in the PCBs (130, 140).

The self-retractive mechanism shown in FIGS. 2P to 2S is one of many possible embodiments to be associated with any kind of connector featuring blind-mating S-FECT technology. In FIGS. 2P and 2Q, the single-piece connector (100) is not mated with the backplane, while the sliding protective cover (110) is fully extended over the pin contacts (123). In FIGS. 2R and 2S the single-piece connector (100) is shown in full mated condition (backplane not shown) with the self-retractive action mechanism (160) in full tension. The self-retractive action is essential for the single-piece connector (100) integrity to maintain the ability to sustain repeated insertion-removal cycles and for the physical protection of the pin contacts (123) situated on the front or blind-mating side of the single-piece connector (100).

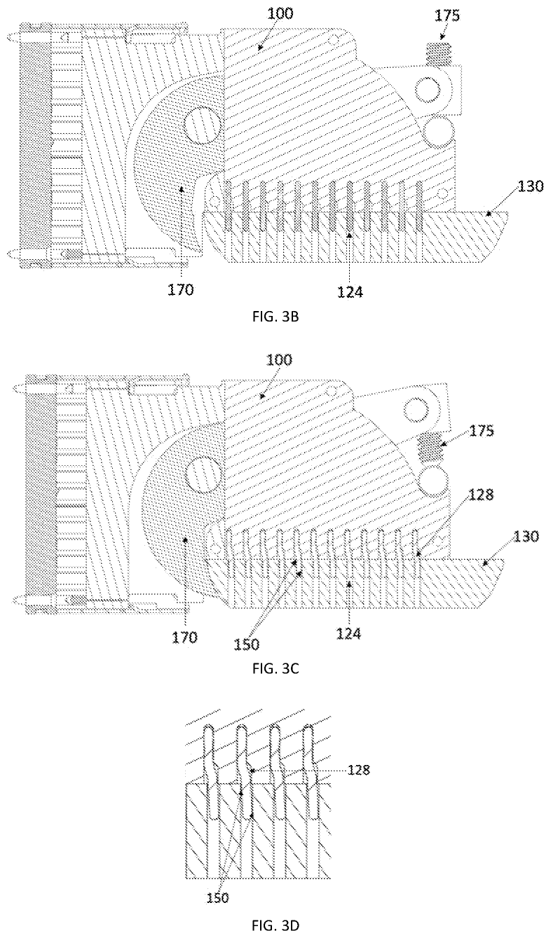

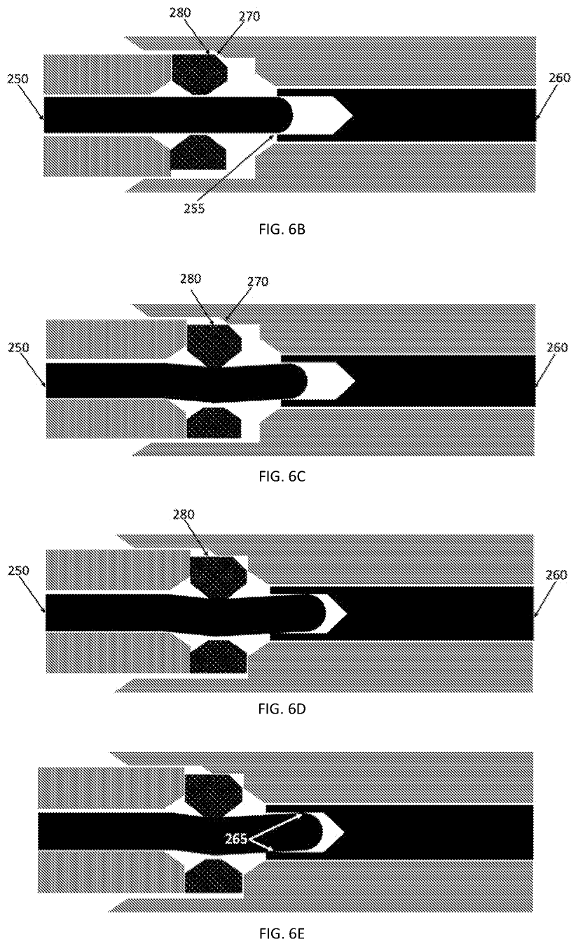

FIGS. 3A to 3D show a third embodiment of the S-FECT Technology, wherein a variation of the rectangular single-piece connector described in the third embodiment of this invention. In this variation, the difference consists in that the locking mechanism comprises a locking and offsetting lever (170) which operates between its “unlocked” to “locked” positions by turning a screw (175). The daughtercard PCB (130) features a rounded edge on the side near the connector, which is routed with an arc coinciding with the arc present at the tip of the lever (170) such that the two surfaces come into coincidental contact regardless of the thickness of the daughtercard PCB (130). The contacts on the daughtercard side of the connector (124) and the PCB footprint (131) line-up accordingly. FIG. 6B shows how the connector (100) is being simply dropped into the footprint all the way without any opposing resistance from the footprint into the daughtercard PCB (130). The locking screw (175) is shown in its fully open position. Then, attending to FIG. 6C, the locking screw (175) is fully locked lifting the lever arm to its maximum upward position and the tip of the lever (170) is shown fully engaged with the front edge of the daughtercard PCB (130) thereby resulting in fully offsetting the contacts (124) and achieving full electromechanical contact (150) between the contacts (124) and the metallized through holes in the PCB. The contacts are placed in elastic deformation within the zone housed by the cavity (128) thereby avoiding a shearing effect on the shafts of the contacts. Finally, FIG. 6D shows in higher detail the areas of electromechanical interface (150) between the contacts and the metallized through holes and also showing the cavity (128) which houses the zone of elastic deformation for the contact.

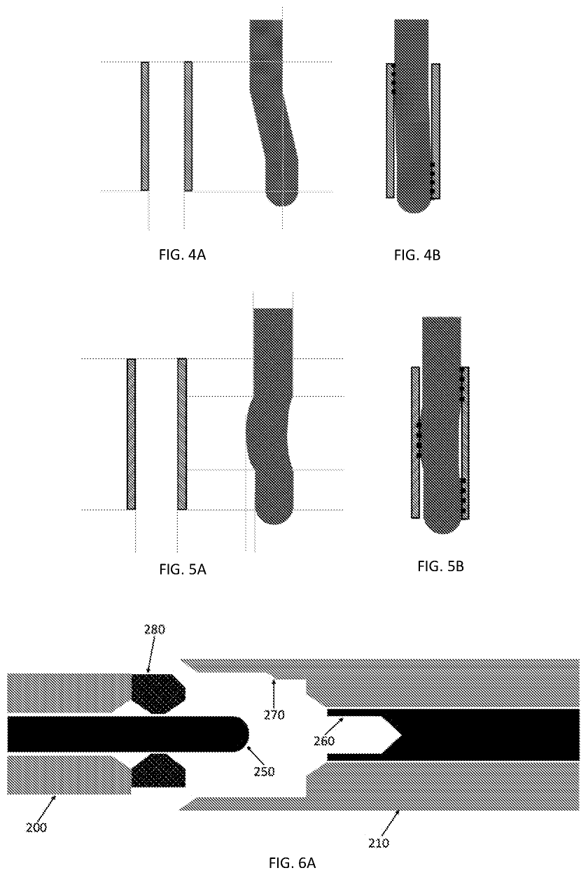

A fourth embodiment of the present invention is shown in FIGS. 4A and 4B with the pretensioned configuration fitted along the body of the male contact or pin in proportion to the diameter of the contact, the diameter of the via hole or tube socket and the height of the zone of interface. This configuration of the contact termination does not require a separate slide-fit offsetting element to apply tension to the contact. This embodiment of Slide-Fit Electrical Contact Termination can be applied to any connector at a contact termination or at a contact mating end. In FIG. 4B it is shown by the black dots the areas where the contact termination achieves effective electromechanical interfacing when inserted into the PCB via hole or into a straight tube socket or female contact because of the pressure realized by the pre-tensioned offset when it is pressed into the tighter inner diameter of the PCB via hole or into a straight tube socket or female contact.

A fifth embodiment of the Slide-Fit Electrical Contact Termination is shown in FIGS. 5A and 5B, with the pretensioned configuration fitted along the body of male contact or pin in the section which interfaces with the via hole or tube socket. This configuration of the contact termination does not require a separate slide-fit offsetting element to apply tension to the contact. This embodiment of Slide-Fit Electrical Contact Termination can be applied to any connector configuration as a contact termination or a contact mating end. In FIG. 5B it is shown by the black dots the areas where the contact termination achieves effective electromechanical interfacing when inserted into the PCB via hole or into a straight tube socket or female contact.

A sixth embodiment of Slide-Fit Electrical Contact Termination is presented in FIG. 6A where a male connector (200) and a female connector (210) are shown. On the Male connector (200) a contact offsetting plate (280) is mounted flush on the connector mating face and allows a male contact (250) to protrude. On the female connector (210), a female contact (260) featuring a drilled cavity, is installed within the female connector (210). The female 30 connector (210) features an offsetting element (270) designed to interface with the offsetting plate (280) during the coupling action of the two connectors. In FIG. 6B it is shown the two connectors being mated and as they come together, the male contact (250) starts mating with the female contact (260) and a slight insertion (255) is being achieved before the offsetting plate (280) comes into contact with the offsetting element (270) which is integrated onto the female connector body. As the mating of the two connectors continues as shown in FIG. 6C, the offsetting element (270) forces the offsetting plate (280) to press perpendicularly onto the body of the male contact (250) starting to cause a longitudinal deflection onto the male contact which begins to place pressure onto the entry face of the female contact (260). As the mating action reaches its maximum penetration. the offsetting plate (280) fully presses onto the body of the male contact (250) which is now fully inserted into the front cavity of the female contact (260). FIG. 6D represents the fully mated condition of the connectors. In FIG. 6E, the electromechanical interface zones (265) are indicated by the white arrows.

Although the foregoing embodiments have been described in some detail for purposes of clarity of understanding. the invention is not limited to the details provided. It should be considered within the scope of protection that there are several ways that a slide-fit electrical contact termination offsetting assembly achieve effective electromechanical connection between male contact terminations or pins and via holes in PCBs with the aid of a mounting and alignment guide equipped with at least one built-in locking clip and at least one built-in offsetting element which force the connector body to slide at right angle with respect to the metallized via holes in the PCB, resulting in placing the contacts under pressure against the via holes in a PCB while permanently securing the connector to the PCB. Also, a slide-fit electrical contact termination offsetting assembly to achieve effective electrical connection between male contact terminations or pins and via holes in PCBs with the aid of at least one built-in offsetting element which force the connector body to slide at right angle with respect to the metallized via holes in the PCB, resulting in placing the contacts under pressure against the via holes in a PCB while permanently securing the connector to the PCB with at least one mounting screw. Furthermore, there are also several variations in which the slide-fit electrical contact termination repetitive blind mating offsetting assembly achieving effective electrical connection between male contact terminations or pins and via holes in a backplane with the aid of a spring-loaded, sliding protective face mounted on a connector using guiding elements to ensure precise blind contact guidance in the backplane footprint and tensioning of all contacts at the same time with a relatively low insertion force and high insertion-removal cycling capability with minimal damage to the via holes inner cavity plating finish and minimal damage to backplane structural integrity. Moreover. a skilled person in the art may identify that the slide-fit electrical contact termination could have at least two configurations of longitudinal pre-tensioning of the contact termination or mating-end, permitting to achieve effective electromechanical connection with via holes into PCBs or with simple tube sockets or female contact cavities which do not need any type of retention or interface features. It should also be noted that the slide-fit electrical contact termination of the present invention could comprise an offsetting interface configuration permitting a constant cross-sectional area of the conductor throughout the length of the conductor including the region of electrical interface with the barrel in which the conductor is inserted, or a post-insertion offset where a sliding element applies pressure perpendicularly to the axis of the male contacts during the mating process starting soon after the contacts have penetrated their mating counterparts and ending when the fully mated condition is achieved, or a post-insertion offset where a sliding element applies pressure perpendicularly to the axis of the male contacts after the contacts have reached their fully mated condition thereby permitting the mating counterparts to fully couple with zero insertion force. For the above mentioned, the disclosed embodiments should be considered illustrative and not restrictive.

1. A slide-fit electrical contact termination offsetting assembly comprising an electrical connector having a plurality of contact terminations placed into a corresponding footprint on a PCB; the slide-fit electrical contact termination offsetting assembly is characterized by:
an alignment bar positioned on the PCB having a corresponding plurality of chamfered holes housing spaces to allow for the elastic deformation of the contacts,
a slide-fit offsetting action element mounted in offset position over a mounting hole, wherein the slide-fit offsetting action element is in contact with the alignment bar, and
a mounting mechanism to retain the connector in position on the PCB, wherein the mounting mechanism interacts with the slide-fit offsetting action element; and
wherein the mounting mechanism displaces laterally the slide-fit offsetting action element, which subsequently forces the alignment bar to slide forcing the contact terminations to jam into the PCB footprint, and the contact terminations are elastically deformed in the chamfered holes within the alignment bar, to achieve effective electromechanical connection between the contact terminations and the PCB.

2. The slide-fit electrical contact termination offsetting assembly in accordance with claim 1, wherein the contact terminations are 90° bent.

3. The slide-fit electrical contact termination offsetting assembly in accordance with claim 1, wherein the contact terminations are solid pin contacts or terminations with a round cross-section, and the footprint is a plurality of plated or metalized through holes in the PCB or any other cylindrical socket/female contact.

4. The slide-fit electrical contact termination offsetting assembly in accordance with claim 1, wherein the chamfered holes are configurated with a spacing which allows the contact terminations to deform elastically without shear.

5. The slide-fit electrical contact termination offsetting assembly in accordance with claim 1, wherein the mounting mechanism is a screw to retain the connector in position through a mounting bracket secured to the body of the connector.

6. A slide-fit electrical contact termination offsetting assembly comprising an electrical connector having at least one plurality of pin contacts placed into a corresponding footprint on a PCB with zero insertion force; the slide-fit electrical contact termination offsetting assembly is characterized by:
a locking mechanism to align the pin contacts with the footprint and allow the insertion into the footprint with zero insertion force,
a slide-fit offsetting action element configured into the locking mechanism, and
the pin contacts are attached to a support element that comprises a corresponding plurality of cavities aside each pin contact; and
wherein the locking mechanism retain the connector on the PCB, and subsequently forces the slide-fit offsetting action element to displace laterally against the PCB forcing the pin contacts to jam into the PCB footprint, and the pin contacts are elastically deformed in the cavity within the support element, to achieve effective electromechanical connection between the contact terminations and the PCB.

7. The slide-fit electrical contact termination offsetting assembly in accordance with claim 6, wherein the connector is a single-piece connector having on both sides of the connector at right angle orientation to each other.

8. The slide-fit electrical contact termination offsetting assembly in accordance with claim 6, wherein the PCB is a daughter card PCB.

9. The slide-fit electrical contact termination offsetting assembly in accordance with claim 6, wherein the cavities allow the pin contacts to deform elastically without shear.

10. The slide-fit electrical contact termination offsetting assembly in accordance with claim 6, wherein the locking mechanism is a guiding lock tab that locks in place on the PCB via a lock lid.

11. The slide-fit electrical contact termination offsetting assembly in accordance with claim 6, wherein the locking mechanism is a locking and offsetting lever which operates between its “unlocked” to “locked” positions, after the connector is placed into the foot print with zero insertion force and the PCB features a rounded edge on the side near the connector, which is routed with an arc coinciding with the arc present at the tip of the lever such that the two surfaces come into coincidental contact regardless of the thickness of the PCB.

12. A slide-fit electrical contact termination offsetting assembly comprising an electrical connector having at least one plurality of pin contacts placed into a corresponding footprint on a PCB; the slide-fit electrical contact termination offsetting assembly is characterized by:
a protective guiding cover to line-up the connector with the PCB having a corresponding plurality of cavities,
a slide-fit offsetting element contained within the protective guiding cover, wherein the slide-fit offsetting action pushes the cover to slide laterally with respect to the connector body, and
a plurality of offsetting pins that interact with the protective guiding cover; and
wherein the protective cover retracts towards the connector and the pin contacts protrude through the cover into the PCB footprint while the offsetting guide pins interact with the inner side of the protective guiding cover and cause the offsetting action to laterally deform the pin contacts into the cavities of the cover, to achieve effective electromechanical connection between the pin contacts and the PCB.

13. The slide-fit electrical contact termination offsetting assembly in accordance with claim 12, wherein the connector is a single-piece connector having pin contacts on both sides of the connector at right angle orientation to each other.

14. The slide-fit electrical contact termination offsetting assembly in accordance with claim 12, wherein the PCB is a backplane PCB.

15. The slide-fit electrical contact termination offsetting assembly in accordance with claim 12, wherein the slide-fit offsetting action element allow the pin contacts to deform elastically without shear.

16. The slide-fit electrical contact termination offsetting assembly in accordance with claim 12, wherein the cover is aligned with a plurality of guide pins to precisely align the connector with the PCB footprint.

17. The slide-fit electrical contact termination offsetting assembly in accordance with claim 12, wherein the cover further comprises a self-retractive action mechanism that permits the cover to auto-retract when the connector is unplugged from the PCB to protect the pin contacts.
